(19) United States
(12) Patent Application Publication
(10) Pub. No.: US 2015/0215334 A1
(43) Pub. Date: Jul. 30, 2015

(54) SYSTEMS AND METHODS FOR GENERATING NETWORK THREAT INTELLIGENCE

(71) Applicant: Level 3 Communications, LLC, Broomfield, CO (US)

(72) Inventors: Skyler J. Bingham, Superior, CO (US); Mahendra K. Chandrakar, Superior, CO (US); Lawrence W. Gowin, Westminister, CO (US); Ryan T. Korte, Louisville, CO (US)

(73) Assignee: Level 3 Communications, LLC, Broomfield, CO (US)

(21) Appl. No.: 14/683,964

(22) Filed: Apr. 10, 2015

Related U.S. Application Data
(63) Continuation-in-part of application No. 14/039,251, filed on Sep. 27, 2013.
(60) Provisional application No. 61/707,310, filed on Sep. 28, 2012.

(51) Int. Cl. H04L 29/06; G06N 99/00

(52) U.S. Cl. CPC H04L 63/1433; G06N 99/005

(57) ABSTRACT

Implementations described and claimed herein provide systems and methods for generating threat intelligence based on network security data. In one implementation, a network traffic dataset representative of network traffic for an Internet Protocol address across one or more ports of a primary network is obtained. A content distribution network log associated with a content distribution network is obtained. The content distribution network log includes a history of content requests by the Internet Protocol address. The network traffic dataset is correlated with the content distribution network log based on the Internet Protocol address to obtain network security data. One or more threat attributes representative of malicious activity are identified from the network security data. The one or more threat attributes are weighted. Network threat intelligence is generated based on the weighted threat attributes using a processing cluster.

### CROSS-REFERENCE TO RELATED APPLICATIONS

The present application is a continuation-in-part of U.S. patent application Ser. No. 14/039,251, entitled “Apparatus, System and Method for Identifying and Mitigation Malicious Network Threats” and filed on Sep. 27, 2013, which claims benefit of priority under 35 U.S.C. §119(e) to U.S. Provisional Patent Application No. 61/707,310, entitled “Apparatus, System and Method for Identifying and Mitigation Malicious Network Threats” and filed on Sep. 28, 2012. Each of these applications is incorporated by reference in their entireties herein.

### TECHNICAL FIELD

Aspects of the present disclosure relate to network security data collection, aggregation, and analysis, among other functions, and more particularly to the generation of network threat intelligence, including reputation scores and profiles, based on network security data.

### BACKGROUND

Computing devices, including laptops and smartphones, connected to the Internet or other networks are generally confronted by interminable security risks. For example, the Internet is plagued by numerous malicious actors utilizing various forms of malware to damage or disable computing devices or systems, steal data, interrupt communications, extort businesses or individuals, and/or steal money, among other nefarious acts. Conventionally, the goal of detecting and mitigating such security risks is burdened by a cycle in which the malicious actors are constantly deploying new malware as defensive technologies are designed to address them. End users are therefore vulnerable until protection against an exploit is developed.

Identifying malicious actors remains a formidable challenge. Conventional security mechanisms may lack insight into the type of data traversing a network or the attributes of the computing device associated with an Internet Protocol (IP) address. As such, it is difficult to differentiate between malicious actors and legitimate end users. For example, end users who naïvely click on or otherwise install infected executables without realizing the consequences of their actions may appear as malicious actors. There is thus an ongoing need to distinguish malicious actors in identifying and addressing network security threats.

It is with these observations in mind, among others, that various aspects of the present disclosure were conceived and developed.

### SUMMARY

Implementations described and claimed herein address the foregoing problems, among others, by providing systems and methods for generating network threat intelligence based on network security data. In one implementation, a network traffic dataset representative of network traffic for an Internet Protocol address across one or more ports of a primary network is obtained. The primary network is in communication with a content distribution network, and the Internet Protocol address corresponds to a computing device. A content distribution network log associated with the content distribution network is obtained. The content distribution network log includes a history of content requests by the Internet Protocol address. The network traffic dataset is correlated with the content distribution network log based on the Internet Protocol address to obtain network security data. One or more threat attributes representative of malicious activity are identified from the network security data. The one or more threat attributes are weighted. Network threat intelligence is generated based on the weighted threat attributes using a processing cluster.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example system for generating network threat intelligence based on network security data.

FIG. 2 illustrates an example network environment for monitoring and correlating network traffic data.

FIG. 3 shows an example network environment for obtaining a content distribution network log and a domain name system log.

FIG. 4 illustrates example operations for generating a reputation score for an IP address based on network security data.

FIG. 5 is an example computing system that may implement various systems and methods discussed herein.

### DETAILED DESCRIPTION

Aspects of the present disclosure involve systems and methods for generating network threat intelligence based on network security data. In one aspect, the network security data is collected, and may include a network traffic dataset, a Content Distribution Network (CDN) log, and a Domain Name System (DNS) log, among other types of data. Based on the unique data sources and attributes of the data, the systems and methods may identify specific threats and take any number of possible actions to address the threats.

A primary network, such as a large Internet Service Provider (ISP) or backbone provider, is uniquely positioned to capture and analyze the network security data. Generally, the network traffic dataset is obtained through the monitoring and correlation of network traffic over one or more ports in the primary network. Stated differently, network traffic data and statistics are gathered from the interaction of the primary network with one or more secondary networks and customer networks and correlated to form a network traffic dataset. The secondary networks may include networks beyond networks adjacent to the primary network. Generally, the network traffic dataset provides snapshots of traffic transceived across the primary network, from which network traffic patterns for at least one Internet Protocol (IP) address are obtained. For example, the network traffic patterns may reveal a pattern of network traffic exchanged between an IP address known to engage in malicious activity and other IP addresses, thereby indicating that the other IP addresses are participating in or otherwise susceptible to an attack. The type of data traversing the primary network and information regarding computing devices associated with the IP addresses exchanging network traffic, however, cannot be directly discerned from the network traffic dataset. As such, the network traffic dataset is correlated with the CDN log, among other types of data, to gain further insight into malicious activity and potential responses to thwart and prevent attacks.

The CDN log and other types of data, such as the DNS log, are obtained based on the interaction of IP addresses with a CDN. Generally, a CDN is a distributed system of servers deployed across a network to serve content with high performance and availability to IP addresses associated with end users. Content served via a CDN may include web objects (e.g., text, graphics, or scripts), downloadable objects (e.g., media files, software, or documents), applications (e.g., e-commerce or portals), streaming media (e.g., live or on-demand), social networks, and the like. Content providers, such as media companies or vendors, may contract with CDN operators to serve their content to their end users, and a CDN may utilize the primary network or other carriers or networks to host its servers.

An end user may request content on a user device connected to a CDN via a customer network. For example, a user may wish to stream a movie on a computer or any other number of possible user devices, as described herein. To start the movie, a link to the movie in a website or other interface may be selected. In some instances, the user may select a graphic of the movie, and that graphic is associated with the link that begins the process of obtaining the movie data from the CDN. Selection of the link in some form causes a request to be sent to a directory server providing a DNS service in the CDN. The directory server responds to the request by providing a network address (e.g., an IP address) from which the movie may be retrieved. The CDN log includes a history of such content requests from and deliveries to various IP addresses, and the DNS log includes a history of network addresses to which various IP addresses were resolved in response to the selection or input of a link (e.g., a Uniform Resource Locator (URL) or other identifier). The network traffic dataset enhanced with the CDN log and the DNS log provides hard data about an IP address and attributes of the IP address.

The network security data is correlated and parsed to determine a user agent, device type, content type, and other attributes corresponding to the IP address. Threat attributes are identified based on the network security data. The threat attributes supply a behavior profile of the IP address with the various activities of the IP address over a time frame. Each of the threat attributes are weighted based on the type of activity, the source, and other factors, established, for example, via machine learning. Based on the weighted threat attributes, network threat intelligence, including a reputation score, is generated. The reputation score represents a confidence level in a likelihood of whether an IP address engages in or is otherwise susceptible to malicious activity. The higher the score, the higher the confidence that the IP address engages in or is otherwise susceptible to malicious activity

Where there is a prevalence of IP addresses engaged in malicious activity concentrated in one network area associated with an IP address, the activity of that area may erroneously implicate the IP address, resulting in false positives of malicious activity. Thus, to ensure that an IP address is not assigned a reputation score that is inherited based upon the activities of other users, a neighborhood score for an internet neighborhood of the IP address is generated, where the internet neighborhood represents a collection of IP addresses related to the IP address at issue. The internet neighborhood may be a netblock (i.e., a set of grouped IP addresses having a start IP address and an end IP address), an autonomous system (AS), a region, a country, and/or other collections of IP addresses related to the IP address at issue.

The neighborhood score provides a reputation score for an internet neighborhood based on weighted threat attributes identified from network security data corresponding to network traffic involving the internet neighborhood. The neighborhood scores demonstrate whether the IP address is sending network traffic associated with malicious activity or simply in an internet neighborhood where such network traffic is frequently exchanged. For example, the IP address may be within a range of IP addresses assigned to a country that frequently participates in network attacks, but the IP address may not be engaged in such attacks. The neighborhood scores in this case may indicate that the reputation score of the IP address is higher than it should be as a result of the activity of the country. As another example, the IP address may be associated with a country lacking access to security updates and thus be more susceptible to malware and to infecting other devices, but the computing device associated with IP address may have nonetheless been able to obtain sufficient security updates. The neighborhood score for the country would be higher based on this susceptibility, which may be erroneously attributed to all the IP addresses within that country. Evaluating the reputation score for the IP address in view of the neighborhood score here would reveal that the reputation score for the IP address may be inflated based on the association of the IP address with the shortcomings of the country. A normalized reputation score for the IP address is thus generated based on the aggregated neighborhood scores for the internet neighborhoods and the reputation score for the IP address. Based on the normalized reputation score for the IP address, the primary network and/or the secondary network, such as a CDN, may respond to a threat by the IP address.

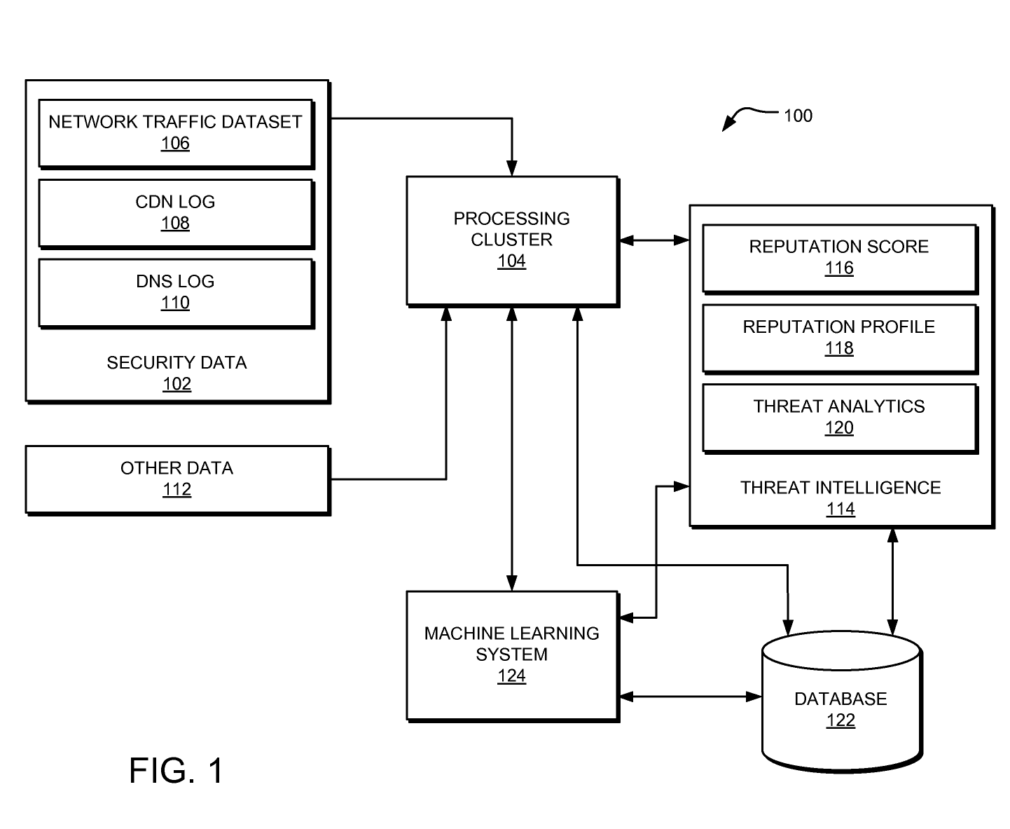

Turning to FIG. 1, an example system 100 for generating network threat intelligence based on network security data 102 is shown. In one implementation, a processing cluster 104 regularly gathers the security data 102 from a variety of trusted sources having information relating to the activity of IP addresses. A primary network, such as a large ISP or backbone provider, includes edge devices, servers, and other network components uniquely positioned to capture the security data 102.

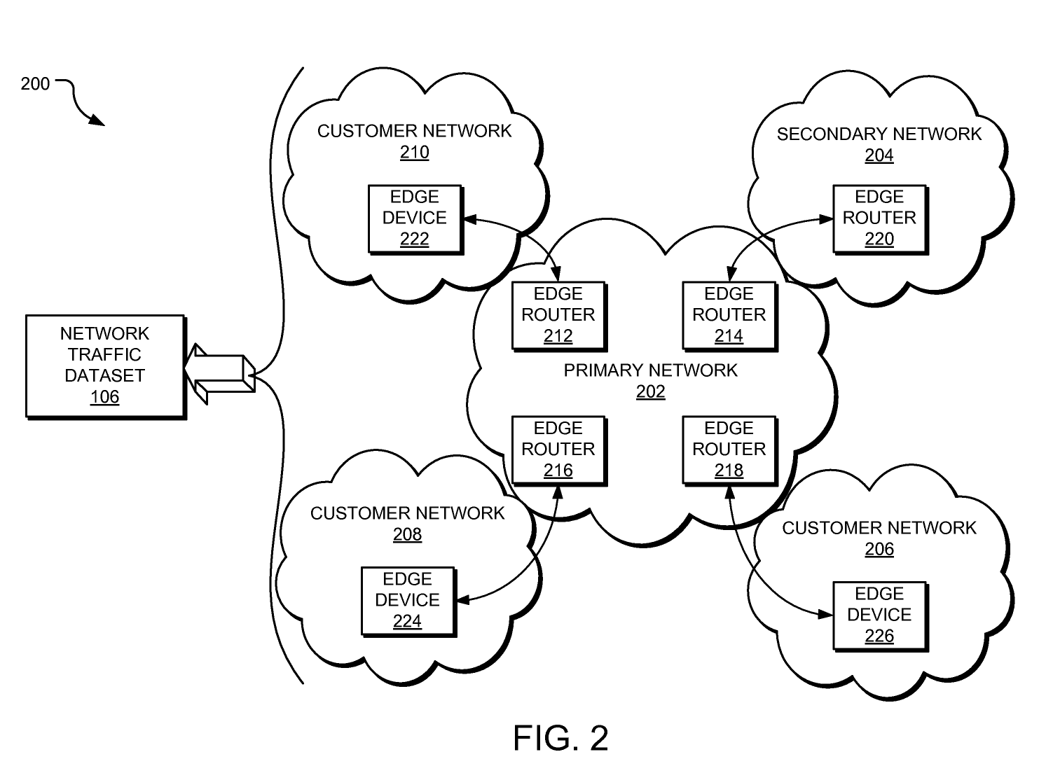

In one implementation, the processing cluster 104 is configured to retrieve a network traffic dataset 106 providing information about IP addresses known to host malicious activity. The network traffic dataset 106 is obtained through the monitoring and correlation of network traffic over one or more ports in the primary network, for example, as described with respect to FIG. 2. The network traffic dataset 106 may be used to identify a gross level of potential malicious actors based on the IP addresses between which traffic is exchanged via the primary network. For example, the network traffic dataset 106 may reveal traffic patterns indicative of a host IP address for a command and control server for a botnet, which is a collection of network-connected programs communicating with other similar programs in order to perform tasks, such as spam email, distributed denial-of-service attacks, or other malicious activity. As such, any IP addresses exchanging traffic with the host IP address are likely bots engaging in the malicious activity. The network traffic dataset 106 thus identifies IP addresses associated with malicious activity.

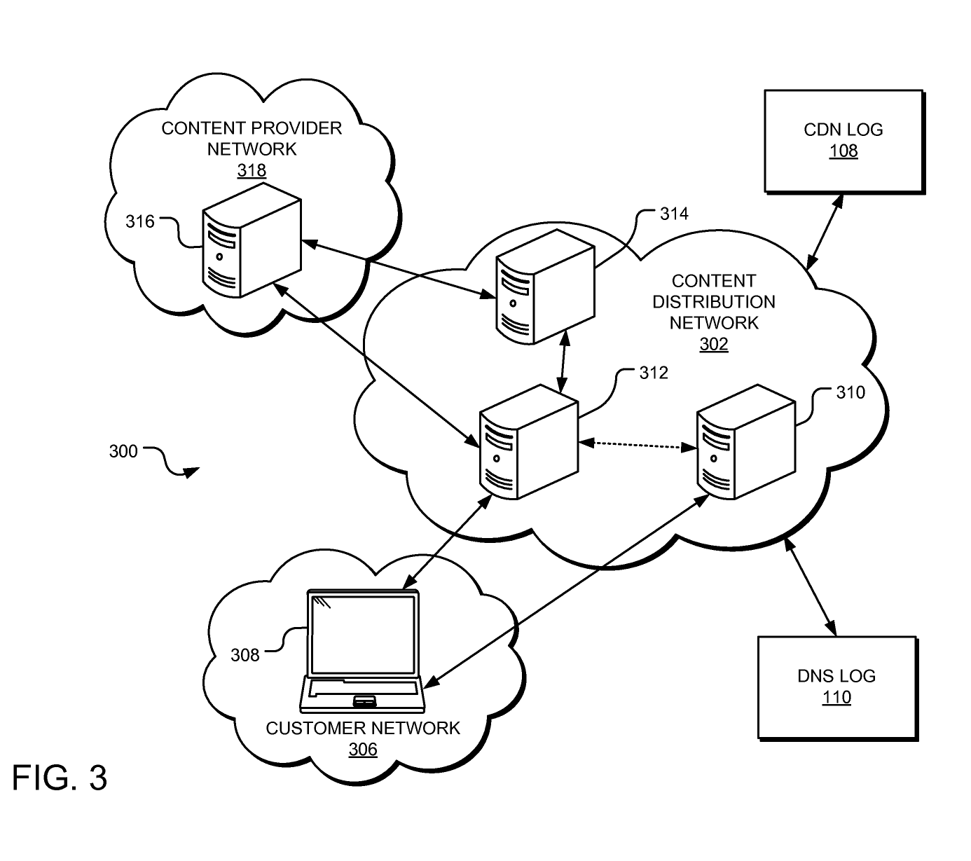

The network traffic dataset 106 may be enhanced with a CDN log 108, and a DNS log 110 to provide insight into the type of data traversing the primary network as well as attributes of the IP address, including characteristics of the computing device associated with the IP address. The CDN log 108 includes a history of content requests from and deliveries to various IP addresses, and the DNS log 110 includes a history of network addresses to which various IP addresses were resolved in response to the selection or input of a link (e.g., a URL or other identifier). The CDN log 108 and the DNS log 110 may be obtained, for example, as described with respect to FIG. 3 and retrieved by the processing cluster 104.

In one implementation, the CDN log 108 includes an Application Layer Routing (ALR) log, which details the IP address, URL request, and user agent (e.g., type of computing device, operating system type and version running on the computing device, other software running on the computing device, etc.), as well as the content requested. The CDN log 108 obtains the user agent from a header included in requests and other communications sent by the computing device and tied to the IP address, which is verified by confirming the extender line (i.e., bidirectional communication between the IP address and the CDN) using Transmission Control Protocol (TCP). The CDN log 108 thus provides information regarding content requested from a CDN and information regarding the computing device requesting the content.

The network traffic dataset 106 enhanced with the CDN log 108 provides granular information regarding the malicious activity associated with the IP address. For example, in the case of a botnet as discussed above, the CDN log 108 includes information about the particular malware deployed from the IP address, including the operating system and software used to design the malware and the operating systems targeted by the malware. Knowing the operating system and other software used to design and deploy malware, as well as the operating systems and computing device types targeted by the malware, assists in identifying and remedying vulnerabilities in the operating systems exploited by the malware and in determining targets susceptible to the malware. This information further provides insight into how malicious actors behave and what they target, thereby informing the development of new or improved security tool. Similarly, knowing the content requested by the IP address deploying the malware may provide information on potential targets. For example, an IP address engaged in malicious activity that frequents healthcare websites may evidence a potential or current threat targeting the healthcare industry.

The security data 102 generally provides a landscape of network threats with granular detail. As discussed above, the network traffic dataset 106 associates an IP address to malicious activity based on the exchange of traffic with IP addresses known to engage in or be vulnerable to such activity. The CDN log 108 provides insight into the type of device associated with the IP address, what software and operating systems are running on the device, and what content is being requested. The requested content may suggest targets for malicious activity. For example, if an IP address associated with malicious activity frequents healthcare sites, the IP address may be targeting actors within the healthcare industry. The DNS log 110 may be used, as described with respect to FIGS. 2-3 to pin the IP address to a particular geographical location. The geographical location of an IP address may inform a threat level based on the vulnerability or malicious activity in the geographical location. For example, a netblock, AS, or country may lack access to security updates and thus be more susceptible to malware and to infecting other devices. The security data 102 thus provides tangible information, rather than mere statistical inference, regarding an IP address and attributes of the IP address, such as location, user agent, requested content, and the like.

Other data 112 may be provided to the processing cluster 104 to provide additional granularity regarding the attributes of the IP addresses. The other data 112 may include one or more enrichment feeds having data that: may be correlated with the end users (i.e., with the IP addresses); relates to one or more networks in communication with the primary network (e.g., secondary or customer networks); and/or otherwise enhances the security data 102. In one implementation, the other data 112 includes data from electrically accessible sources relating to the activities of IP addresses and domains. These sources may include, without limitation, honeypots (i.e., a computer, data, or network site appearing as part of a network but is actually isolated and monitored to investigate malicious activity), Open Source Intelligence (OSI) databases, trusted partner databases, intrusion detection system alerts, spam origins, abuse complaints, and the like.

In one implementation, the processing cluster 104 communicates with and retrieves the security data 102 and/or the other data 112 at regularly scheduled intervals. In another implementation, the processing cluster 104 receives the security data 102 and/or the other data 112 in substantially real time. In still another implementation, the processing cluster 104 retrieves the security data 102 and/or the other data 112 in response to a manual command. The processing cluster 104 may receive data over a network (e.g., the Internet, an enterprise intranet, etc.), via an Application Programming Interface (API) for a source, and/or the like.

The processing cluster 104 is configured to parse, tag, and/or associate data elements for storage and analysis. The processing cluster 104 may include various modules, components, systems, infrastructures, and/or applications that may be combined in various ways, including into a single software application or multiple software applications. The security data 102 and the other data 112 provided to the processing cluster 104 is stored in one or more non-relational databases 122, in one specific implementation. The processing cluster 104 is a distributed, scalable storage layer that is configured to store a large volume of structured and unstructured data. In one implementation, the processing cluster 104 replicates and distributes blocks of data through cluster nodes, along with numerous other features and advantages. As such, the processing cluster 104 generally manages the processing, storage, analysis, and retrieval of large volumes of data in the non-relational database 122. The processing cluster 104 may include, for example, Storm, Hadoop®, or the like.

In one implementation, the security data 102 and/or the other data 112 is received at one or more router interfaces, which is running an agent, such as Flume or other aggregation modules. The agent extracts, ingests, and imports the security data 102 and/or the other data 112 into the processing cluster 104, where the security data 102 and/or the other data 112 is transformed, aggregated, parsed, and assigned relevancy values and locations for storage in the database 122. In one implementation, prior to input into the processing cluster 104, the security data 102 and/or the other data 112 is timestamped using a messaging bus, which may be, for example, Apache Kafka, zeromq, or the like.

The processing cluster 104 serializes and stores the security data 102 and/or the other data 112, such that network threat intelligence 114 may be generated based on a query. The processing cluster 104 processes a query in multiple parts at the cluster node level and aggregates the results to generate the network threat intelligence 114. In one implementation, the processing cluster 104 receives a query in structured query language (SQL), aggregates data stored in the database 122, and outputs the threat intelligence 114 in a format enabling further management, analysis, and/or merging with other data sources.

In one implementation, in serializing the security data 102 and/or the other data 112, the processing cluster 104 filters and packages the data into a uniform record format for storage in the database 122. During filtering, any irrelevant information, including misinformed information, is removed. The filtered data is then normalized into a standard format and aggregated based on IP address into a record with duplicate records removed. The processing cluster 104 assigns relevancy values to the records based on the data in the record and/or information retrieved from an internal or external source. The relevancy values may involve the IP address, the computing device, and the user agent. The processing cluster 104 utilizes the relevancy values in generating the threat intelligence 114 in response to a query.

The processing cluster 104 may generate the threat intelligence 114 using machine learning techniques deployed with a machine learning system 124. The machine learning techniques provided by the machine learning system 124 generally involve a machine learning through observing data that represents incomplete information about statistical happenings and generalizing such data to rules and/or algorithms that make predictions for future data, trends, and the like. Machine learning typically includes “classification” where machines learn to automatically recognize complex patterns and make intelligent predictions for a class.

Generally, the threat intelligence 114 identifies IP addresses associated with malicious actors and differentiates such actors from legitimate end users. In one implementation, the threat intelligence 114 involves a correlation of IP addresses, user agents, geographical locations, and content requests. The threat intelligence 114 may include a reputation score 116, a reputation profile 118, and threat analytics 120. Based on the threat intelligence 114, a response to threats by a particular IP address may be determined.

In one implementation, the reputation score 116 involves weighting threat attributes of the security data 102 to identify and/or predict the presence of malicious activity. The processing cluster 104 assigns a weight to each threat attribute in a record that corresponds to a nature of the associated threat, including a type of activity and a source of data indicating the activity. For example, a low weight may be assigned to threat attributes related to port 80 (i.e., the default port for insecure Internet connection) because it is common to have traffic on port 80. Conversely, a higher weight may be assigned to threat attributes related to other ports with lower traffic activity because any traffic on through such ports is rare, which may be indicative of malicious activity. Similarly, sending spam may receive a lower weight than participation in a botnet. In one implementation, the machine learning system 124 assigns a weight or dynamically readjusts a weight for threat attributes. For example, the machine learning system 124 may track future activity and effects of that activity compared to the assigned weights for that activity to dynamically adjust weights for similar activity. The processing cluster 104 parses the weighted threat attributes and uses the parsed weighted threat attributes to generate a baseline reputation score for each IP address.

The reputation score 116 is a single value (e.g., a percentage) representing a confidence level in a likelihood of whether an IP address engages in or is otherwise susceptible to malicious activity. The higher the reputation score 116 the higher the confidence that the IP address engages in or is otherwise susceptible to malicious activity. Where there is a prevalence of IP addresses engaged in malicious activity concentrated in one network area associated with an IP address, the activity of that area may erroneously implicate the IP address, resulting in an inflated reputation score 116 for the IP address. To ensure that an IP address is not assigned a reputation score 116 that is inherited based upon the activities of other users, a neighborhood score for an internet neighborhood of the IP address is generated. The internet neighborhood represents a collection of IP addresses related to the IP address at issue and may be a netblock, an AS, a region, a country, and/or other collections of IP addresses.

The neighborhood score provides a reputation score for an internet neighborhood based on weighted threat attributes identified from the network security data 102 corresponding to the internet neighborhood. Specifically, threat attributes are identified from the network security data 102 based on the various activities of the IP addresses within the internet neighborhood over a time frame, thereby supplying a behavior profile of the internet neighborhood. Each of the threat attributes are weighted based on the type of activity, the reporting source, and other factors, established, for example, via machine learning, as described herein with respect to the reputation score 116. Based on the weighted threat attributes, the neighborhood score for the internet neighborhood is generated.

The neighborhood scores demonstrate whether the IP address is sending network traffic associated with malicious activity or simply in an internet neighborhood where such network traffic is frequently exchanged. For example, the IP address may be within a range of IP addresses assigned to a country that frequently participates in network attacks, but the IP address may not be engaged in such attacks. The neighborhood scores in this case may indicate that the reputation score 116 of the IP address is higher than it should be as a result of the activity of the country. As another example, the IP address may be associated with a country lacking access to security updates and thus be more susceptible to malware and to infecting other devices, but the computing device associated with IP address may have nonetheless been able to obtain sufficient security updates. The neighborhood score for the country would be higher based on this susceptibility, which may be erroneously attributed to all the IP addresses within that country. Evaluating the reputation score 116 for the IP address in view of the neighborhood score here would reveal that the reputation score 116 for the IP address may be erroneously inflated based on the association of the IP address with the shortcomings of the country.

The processing cluster 104 thus generates a neighborhood score for each of the internet neighborhoods of the IP address and normalizes the reputation score 116 based on the neighborhood scores for the internet neighborhoods. As such, the reputation score 116 is a normalized reputation score for the IP address taking into account the activity of the IP address and the activity of other uses that may be influencing a perceived threat level of the IP address. In one implementation, the processing cluster 104 regularly updates the reputation score 116 based on current activity by the associated IP address as the security data 102 is regularly collected, parsed, and analyzed.

In one implementation, the processing cluster 104 and/or the machine learning system 124 evaluates the reputation score 116 to generate the reputation profile 118, which provides detail regarding the weighted threat attributes and/or the basis of the reputation score, including activity of the IP address demonstrating that the IP address is engaging in or vulnerable to malicious activity. For example, a computing device operating at an IP address with no firewall, open ports, and/or outdated software may not be actively or intentionally engaging in malicious activity. However, given the vulnerability of the computing device to malware, the IP address may receive a higher reputation score 116.

A user may query the processing cluster 104 to obtain the reputation score 116 and/or the reputation profile 118 for one or more IP addresses to facilitate responding to network threats without limiting the network activity of legitimate end users. The reputation score 116 and/or the reputation profile 118 may be replicated to memory caches in edge servers, so the user experiences reduced latency when querying the processing cluster 104. In one implementation, the reputation score 116 may be used to determine a source of a current attack and respond accordingly. A high reputation score 116 represents a high confidence that the IP address is engaged in malicious behavior and thus may merit a relatively strong response, such as dropping the traffic emanating from the IP address at the network edge. The reputation score 116 thus informs traffic filtering during an attack, so network traffic from those IP addresses likely to be participating in the attack may be dropped without denying service to those likely to be legitimate users.

The threat analytics 120 may include trends in network threats, maps providing visual representations of network threats or trends, predictions of future activity, proposed responses to threats, effectiveness of responses to threats, and the like. The trends in network threats may provide insight into changes in malicious activities and the relationship of such activities to attributes of IP addresses. For example, the trends may indicate an increase in the occurrence of malware targeting Windows® operating systems. In one implementation, the threat analytics 120 include a map correlating geographical regions to the reputation score 116 of IP addresses within those regions. In another implementation, the threat analytics 120 include a map correlating device type, operating system, software, and/or the like with market and the reputation score 116 of the IP addresses within the market. For example, the map may reveal a particular country with a high reputation score 116 due to a high occurrence of computing devices running Windows® susceptible to malicious activity in the country based on a lack of access to Windows® security updates.

In one implementation, the threat analytics 120 inform a determination of a threshold for filtering network traffic or otherwise responding to malicious activity based on the reputation score 116. Stated differently, network traffic exchanged with IP addresses having a reputation score 116 above a threshold (e.g., 50%) may be filtered, with the threshold set using the threat analytics 120. The threshold may be set based on various factors, including, without limitation, business practices, vulnerability to malicious activities, factors established using the machine learning system 124, customer feedback, and the like.

For example, the business practices of a mail server may emphasize accepting legitimate mail without accepting spam. Because an IP address engaged in spamming is assigned a reputation score 116 that is relatively lower than other malicious activity, such as a command center for a botnet, but higher than legitimate network traffic, the reputation score 116 score may be used to identify and respond to spam. Here, the threat analytics 120 may set thresholds preventing IP addresses having a reputation score 116 reflecting the participation in spamming from sending mail via the mail server. As another example, a network may want to avoid alienating potential customers by filtering their traffic, so the threat analytics 120 may provide for a higher threshold, thereby potentially tolerating malicious activity on the level of spamming, for example, but not rising to the level of participation in a botnet. On the other hand, other networks may involve sensitive data, and thus the threat analytics 120 may provide for a lower threshold, potentially eliminating some legitimate network traffic.

In one implementation, a network may provide feedback to an IP address having a reputation score 116 below the threshold to assist the end user in remedying the issues causing the high reputation score 116 and/or avenues for challenging the reputation score 116. For example, a secure network, such as a banking website, may issue an alert to an IP address having a reputation score 116 above the threshold informing the user that they are vulnerable to malicious activity and are consequently denied access to the site to protect the integrity of their banking data, computers and network. The alert may further direct the user to an isolated and secure computing environment with instructions for remedying the vulnerabilities and therefore their reputation score 116. For example, the alert may include a link to a secure site providing access to relevant security updates, including without limitation, security patches for software or operating systems, current versions of software or operating systems, and/or the like.

In one implementation, the threat analytics 120 proposes responses to threats based on the reputation scores 116 of the IP addresses associated with the threats, among other factors. The proposed responses may include, without limitation, null routing network traffic associated with the threat, logically separating a malicious network, pushing information relating to the threat to firewalls on a friendly (i.e., known to be secure) network for the firewalls to block any traffic from the threat source, using access control list (ACL) blocks, and the like. The threat intelligence 114, as well as information regarding a threat, may be provided to other networks for use in blocking malicious activity.

Turning to FIG. 2, an example network environment 200 for monitoring and correlating network traffic data is shown. In one implementation, a primary network 202 is in communication with various other networks, including a secondary network 204 and customer networks 206, 208, and 210. The primary network 202 may be from a large provider, such as a backbone provider, that facilitates communication and exchanges traffic between the secondary network 204 and the customer networks 206, 208, and 210. The customer networks 206, 208, and 210 may be wired or wireless networks under the control of or operated/maintained by one or more entities, such as an Internet Service Provider (ISP) or Mobile Network Operator (MNO) that provides access to the primary network 202. Thus, for example, the customer networks 206, 208, and 210 may provide Internet access to one or more end users. The secondary network 204 may be, for example, a CDN. Although three customer networks and one secondary network are shown in the network environment 200, more or fewer customer and/or secondary networks may interface with the primary network 202. Furthermore, the network environment 200 may include endpoints beyond networks adjacent to the primary network 202.

The primary network 202 includes multiple ingress/egress routers (e.g. edge routers 212-218), which may have one or more ports, in communication with the secondary network 204 and the customer networks 206-210. For example, the edge router 214 of the primary network 202 interfaces with an edge router 220 of the secondary network 204, and the edge routers 212, 216, and 218 of the primary network 202 interface with edge devices 222, 224, and 226 of the customer networks 210, 208, and 206, respectively. The edge devices 222, 224, and 226 are network devices that provide entry points into the primary network 202 via the customer networks 206-210. Stated differently, one or more end users may connect to the Internet with a user device using one of the edge devices 222-226. The user device may be any form of computing device, including, without limitation, a personal computer, a terminal, a workstation, a mobile phone, a mobile device, a tablet, a set top box, a multimedia console, a television, or the like. In some implementations, the edge routers 212-218 communicate with each other across the primary network 202 over multiple iterations and hops of other routers contained within the primary network 202. Similarly, the customer networks 206-210 and/or the secondary network 204 may include edge routers that communicate with other routers via one or more hops and interface with another network, gateway, end user, or the like.

In one implementation, the networks 202-210 exchange network traffic using border gateway protocol (BGP). BGP is a telecommunications industry standard for an inter-autonomous system routing protocol (i.e., a connected group of one or more IP prefixes run by one or more network operators which has a single and clearly defined routing policy), including support for both route aggregation and Classless Inter Domain Routing (CIDR) between the networks 202-210 and one or more interconnection points.

Network traffic data is captured on the edge routers 212-218 and enriched using BGP data, router details, location information, volume adjustment data, customer identifiers, and the like. Stated differently, network traffic data and statistics are gathered from the interaction of the primary network 202 with the secondary network 204 and the customer networks 206-210 and correlated to form the network traffic dataset 106. The network traffic dataset 106 provides information about sources, destinations, ingress/egress points, and other information about network traffic across the primary network 202. In other words, the network traffic dataset 106 may be used to evaluate network behavior and network traffic patterns of the primary network 202 with respect to network traffic transceived between (i.e., sent to and received by) various IP addresses via the secondary network 204 and/or the customer networks 206-210.

The network traffic dataset 106 includes information on the identity of who sends and receives network traffic at a particular router interface (e.g., the edge routers 212-218) in the primary network 202. This information may include, for example, a router identifier, an interface identifier for the particular router, an origin AS number, a destination AS number, and the like. The network traffic dataset 106 may also include an estimation or approximation of the amount or rate of traffic transceived at the edge routers 214-218 in the primary network 202. In one implementation, the network traffic dataset 106 includes network traffic amounts and rates collected using Simple Network Management Protocol (SNMP) counters and messaging. In another implementation, the network traffic dataset 106 includes information collected from BGP tables associated with the connectivity relationships of the primary network 202 with the secondary network 204 and the customer networks 206-210. The BGP tables may include routing tables having connectivity information (e.g., IP addresses, AS paths, etc.) that provide which destinations are reachable from a particular ingress router in a network that interfaces with an egress router in the primary network 202. With egress AS numbers, it may be determined to which network (e.g., the secondary network 204 and/or the customer networks 206-210) network traffic is being sent.

In one implementation, the network traffic dataset 106 specifies the sender and the receiver of a data transmission over the primary network 202. For example, a router interface identifier, an IP address, router device identifier, or the like may be used to determine the network from which a transmission is being sent. Similarly, the network traffic dataset 106 may be used for geo-location purposes to determine a geographic location or proximity of a sender and a receiver of a data transmission (e.g., associated with an origination and/or destination IP address).

As described herein, the network traffic dataset 106 may be used to identify malicious network activity based on network traffic patterns. In one implementation, the processing cluster 104 identifies network traffic patterns, IP addresses deploying malware or engaging in other malicious activity, suspect networks, and the like.

In one implementation, the processing cluster 104 identifies malicious activity involving a botnet based on the network traffic dataset 106. As described herein, a botnet is generally a collection of infected computing devices utilized for malicious activity, often without the knowledge of the users of such computing devices. A command and control server distributes malware to the computing devices, thereby establishing control through the creation of a bot. Botnets may be used to deploy denial of service (DOS) attacks involving a large volume of requests sent to a website, content provider, or other service to overwhelm and crash the site by exhausting the available bandwidth. Distributed DOS (DDOS) involve an attack emanating from multiple IP addresses in multiple locations, thereby making such attacks difficult to identify and prevent.

DOS or DDOS attacks may be discerned from the network traffic dataset 106 based on network traffic patterns, including traffic volume and traffic rate, for one or more IP addresses. For example, the network traffic dataset 106 may identify the source IP address associated with the command and control server controlling bots in a DDOS attack by tracing the communications from target to the bots to the source. In one implementation, the initial transmission of bots or other malware may be identified using the network traffic dataset 106 based on a series of packets with the same size transceived between a common source IP address and multiple end IP addresses. Legitimate network traffic from an IP address will involve packets of various sizes based on the content requested or the activities engaged in by the IP address. Conversely, an IP address engaged in malicious activity, such as participation in a botnet, will often involve transmission of the same data to numerous other IP addresses, which will appear as a series of packets of the same size sent to those other IP addresses. The network traffic dataset 106 may further be used to distinguish traffic corresponding to malicious activity based on a source port. For example, traffic often emanates from port 20 or port 80 corresponding to File Transfer Protocol (FTP) and Hypertext Transfer Protocol (HTTP) traffic, respectively, so traffic emanating from other ports may indicate malicious activity.

As described herein, the information that may be gleaned from the network traffic dataset 106, and may be enhanced using the CDN log 108 and the DNS log 110. For a detailed discussion of an example network environment 300 for obtaining the CDN log 108 and the DNS log 110, reference is made to FIG. 3. As shown, the network environment 300 includes a CDN 302, which may include components of one or more networks. In one implementation, the CDN 302 is communicatively coupled to one or more customer networks 306. The customer network 306 may be wired or wireless networks under the control of or operated/maintained by one or more entities, such as an ISP or MNO, that provide access to the CDN 302. Thus, for example, the customer network 306 may provide Internet access to one or more user devices 308, as described herein.

The CDN 302 is capable of providing content to the user device 308. The content may include, without limitation, videos, multimedia, images, audio files, text, documents, software, data files, patches, web content, and other electronic resources. The user device 308 is configured to request, receive, process, and present content. In one implementation, the user device 308 includes an Internet browser application with which a link (e.g. a hyperlink) to content may be selected or otherwise entered, causing a request to be sent to a directory server 310 in the CDN 302.

The directory server 310 responds to the request by providing a network address (e.g., an IP address) where the content associated with the selected link can be obtained. In one implementation, the directory server 310 provides a domain name system (DNS) service, which resolves an alphanumeric domain name to an IP address. The directory server 310 resolves the link name (e.g., a URL or other identifier) to an associated network address from which the user device 308 can retrieve the requested content. The DNS log 110 includes a list of DNS requests and information about the requests, including the network addresses. It will be appreciated by those skilled in the art that the DNS log 110 may also be obtained in other network environments not involving content distribution.

In one implementation, the CDN 302 includes an edge server 312, which may cache content from another server to make it available in a more geographically or logically proximate location to the user device 308. The edge server 312 is configured to provide requested content to a requestor, which may be the user device 308 or an intermediate device in the customer network 306 or in the CDN 302. In one implementation, the edge server 312 provides the requested content that is locally stored in cache. In another implementation, the edge server 312 retrieves the requested content from another source, such as a media access server, a content distribution server 314, or a content origin server 316 of a content provider network 318. The content is then served to the user device 308 or another intermediate device in response to requests for content. The CDN log 108 includes a list of content requests and responses to the requests, including what content or other inventory was requested and served. The CDN log 108 further includes the IP address of the user device 308, which is confirmed with TCP, as well as the user agent of the user device 308, including the operating system running on the user device 308, the type of computing device, the software running on the user device 308, and the like.

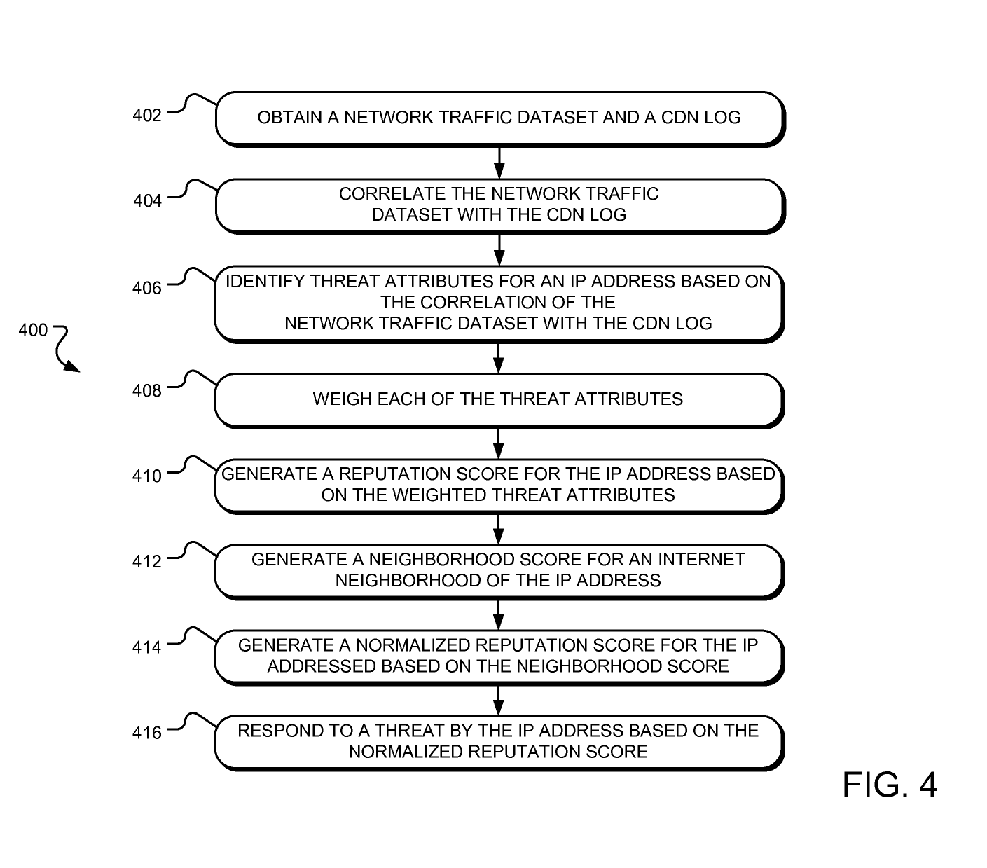

Turning to FIG. 4, example operations 400 for generating a reputation score for an IP address based on network security data. In one implementation, an operation 402 obtains a network traffic dataset and a CDN log, and an operation 404 correlates the network traffic dataset with the CDN log.

In one implementation, an operation 406 identifies threat attributes for an IP address based on the correlation of the network traffic dataset with the CDN log. For example, the correlation may reveal a pattern of network traffic exchanged between an IP address known to engage in malicious activity and other IP addresses, thereby indicating that the other IP addresses are participating in or otherwise susceptible to an attack. An operation 408 weights each of the threat attributes. Each of the threat attributes are weighted based on the type of activity, the source, and other factors, established, for example, via machine learning. An operation 410 generates a reputation score for the IP address based on the weighted threat attributes.

To ensure that an IP address is not assigned a reputation score that is inherited based upon the activities of other users, an operation 412 generates a neighborhood score for an internet neighborhood of the IP address. The internet neighborhood may be a netblock, an AS, a region, a country, and/or the like. The operation 412 may generate a neighborhood score for each of the internet neighborhoods of the IP addresses. An operation 414 generates a normalized reputation score for the IP address based on the neighborhood scores for the internet neighborhoods and the reputation score. Based on the normalized reputation score for the IP address, an operation 416 responds to a threat by the IP address. The responses may include, without limitation: filtering network traffic sent from the IP address; null routing network traffic associated with the threat; logically separating a malicious network; pushing information relating to the threat to firewalls on a friendly network for the firewalls to block any traffic from the threat source; using ACL blocks; providing information regarding the threat, the normalized reputation score, and/or the IP address to other networks for use in blocking malicious activity; publishing a list of malicious actors, including the IP address; not responding to a CDN request by the IP address; and the like.

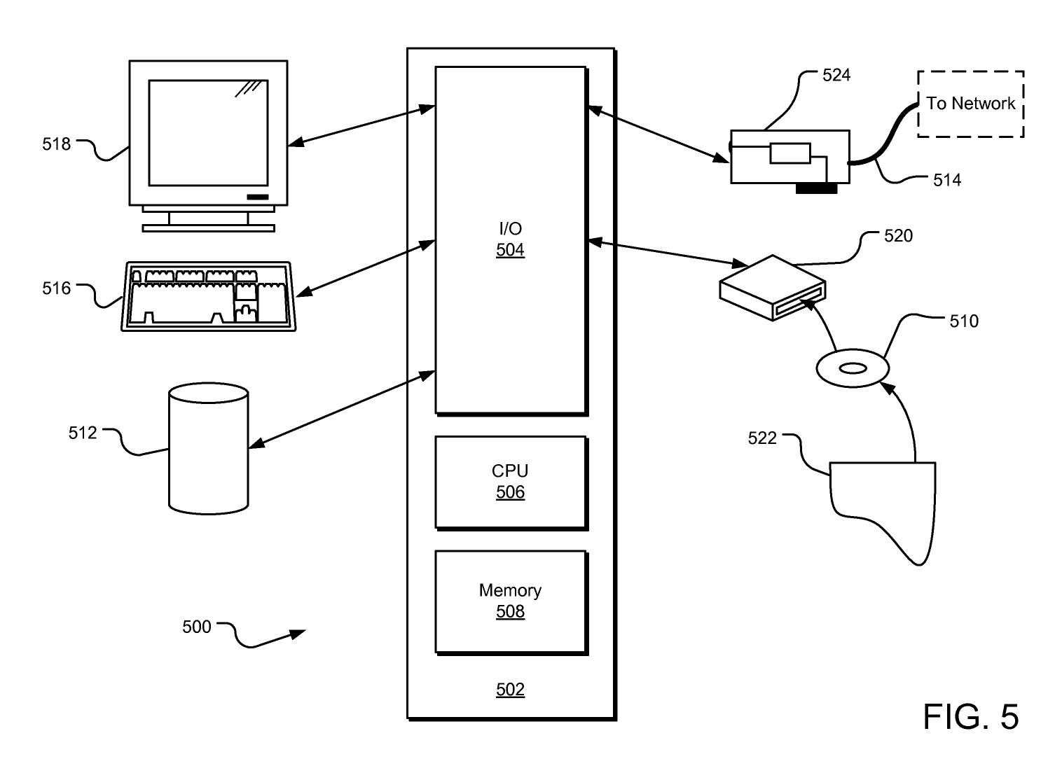

Referring to FIG. 5, a detailed description of an example computing system 500 having one or more computing units that may implement various systems and methods discussed herein is provided. The computing system 500 may be applicable to the user devices, servers, processing cluster, machine learning system, and other computing or network devices. It will be appreciated that specific implementations of these devices may be of differing possible specific computing architectures not all of which are specifically discussed herein but will be understood by those of ordinary skill in the art.

The computer system 500 may be a general computing system is capable of executing a computer program product to execute a computer process. Data and program files may be input to the computer system 500, which reads the files and executes the programs therein. Some of the elements of a general purpose computer system 500 are shown in FIG. 5 wherein a processor 502 is shown having an input/output (I/O) section 504, a Central Processing Unit (CPU) 506, and a memory section 508. There may be one or more processors 502, such that the processor 502 of the computer system 500 comprises a single central-processing unit 506, or a plurality of processing units, commonly referred to as a parallel processing environment. The computer system 500 may be a conventional computer, a distributed computer, or any other type of computer, such as one or more external computers made available via a cloud computing architecture. The presently described technology is optionally implemented in software devices loaded in memory 508, stored on a configured DVD/CD-ROM 510 or storage unit 512, and/or communicated via a wired or wireless network link 514, thereby transforming the computer system 500 in FIG. 5 to a special purpose machine for implementing the described operations.

The I/O section 504 is connected to one or more user-interface devices (e.g., a keyboard 516 and a display unit 518), a disc storage unit 512, and a disc drive unit 520. In the case of a tablet device, the input may be through a touch screen, voice commands, and/or Bluetooth connected keyboard, among other input mechanisms. Generally, the disc drive unit 520 is a DVD/CD-ROM drive unit capable of reading the DVD/CD-ROM medium 510, which typically contains programs and data 522. Computer program products containing mechanisms to effectuate the systems and methods in accordance with the presently described technology may reside in the memory section 504, on a disc storage unit 512, on the DVD/CD-ROM medium 510 of the computer system 500, or on external storage devices made available via a cloud computing architecture with such computer program products, including one or more database management products, web server products, application server products, and/or other additional software components. Alternatively, a disc drive unit 520 may be replaced or supplemented by an optical drive unit, a flash drive unit, magnetic drive unit, or other storage medium drive unit. Similarly, the disc drive unit 520 may be replaced or supplemented with random access memory (RAM), magnetic memory, optical memory, and/or various other possible forms of semiconductor based memories commonly found in smart phones and tablets.

The network adapter 524 is capable of connecting the computer system 500 to a network via the network link 514, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as terminals, workstations, mobile phones, tablets, laptops, personal computers, multimedia consoles, gaming consoles, set top boxes, and the like.

When used in a LAN-networking environment, the computer system 500 is connected (by wired connection or wirelessly) to a local network through the network interface or adapter 524, which is one type of communications device. When used in a WAN-networking environment, the computer system 500 typically includes a modem, a network adapter, or any other type of communications device for establishing communications over the wide area network. In a networked environment, program modules depicted relative to the computer system 500 or portions thereof, may be stored in a remote memory storage device. It is appreciated that the network connections shown are examples of communications devices for and other means of establishing a communications link between the computers may be used.

In an example implementation, network security data collection, parsing, correlating, and analyzing software, threat intelligence software, and other modules and services may be embodied by instructions stored on such storage systems and executed by the processor 502. Some or all of the operations described herein may be performed by the processor 502. Further, local computing systems, remote data sources and/or services, and other associated logic represent firmware, hardware, and/or software configured to control operations of the processing cluster 104, the various servers, user devices, network components, and/or computing units. Such services may be implemented using a general purpose computer and specialized software (such as a server executing service software), a special purpose computing system and specialized software (such as a mobile device or network appliance executing service software), or other computing configurations. In addition, one or more functionalities of the systems and methods disclosed herein may be generated by the processor 502 and a user may interact with a Graphical User Interface (GUI) using one or more user-interface devices (e.g., the keyboard 516 and the display unit 518) with some of the data in use directly coming from online sources and data stores.

The system set forth in FIG. 5 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for identifying network threats, the method comprising:
obtaining a network traffic dataset representative of network traffic for an Internet Protocol address across one or more ports of a primary network, the primary network in communication with a content distribution network, the Internet Protocol address corresponding to a computing device;
obtaining a content distribution network log associated with the content distribution network, the content distribution network log including a history of content requests by the Internet Protocol address;
correlating the network traffic dataset with the content distribution network log based on the Internet Protocol address to obtain network security data;
identifying one or more threat attributes representative of malicious activity from the network security data;
weighting the one or more threat attributes; and
generating network threat intelligence based on the weighted threat attributes using a processing cluster.

2. The method of claim 1, wherein the one or more threat attributes are weighted using machine learning.

3. The method of claim 1, wherein the one or more threat attributes are weighted based on at least one of a type of activity of the malicious activity or a source reporting the malicious activity.

4. The method of claim 1, wherein the network traffic dataset and the content distribution network log are further correlated with domain name system log associated with the content distribution network based on the Internet Protocol address.

5. The method of claim 1, wherein the network traffic dataset and the content distribution network log are further correlated with other data from one or more enrichment feeds based on the Internet Protocol address.

6. The method of claim 1, wherein the network threat intelligence includes a reputation score for the Internet Protocol address.

7. The method of claim 6, the reputation score is normalized based on one or more neighborhood scores, each of corresponding to an internet neighborhood of the IP address.

8. The method of claim 7, wherein the internet neighborhood is a netblock, an autonomous system, a region, or a country.

9. The method of claim 1, wherein the network threat intelligence includes threat analytics.

10. The method of claim 9, wherein the threat analytics includes at least one of: network threat trends; maps providing visual representations of the network threats; predictions of future malicious activity; proposed responses to the network threats; or an effectiveness of responses to the network threats.

11. The method of claim 1, further comprising:
responding to a threat by the Internet Protocol address based on the network threat intelligence.

12. The method of claim 11, wherein the response includes at least one of: filtering future network traffic sent from the Internet Protocol address; null routing future network traffic associated with the threat; logically separating a malicious network associated with the Internet Protocol address; pushing data relating to the threat to firewalls on a friendly network; using Access Control List blocks; providing information regarding the Internet Protocol address to other networks for use in blocking future network traffic; publishing a list of malicious actors, including the Internet Protocol address; or not responding to a future content request by the Internet Protocol address to the content distribution network.

13. One or more non-transitory tangible computer-readable storage media storing computer-executable instructions for performing a computer process on a computing system, the computer process comprising:
extracting network traffic patterns for an Internet Protocol address from a network traffic dataset representative of network traffic for an Internet Protocol address across one or more ports of a primary network, the primary network in communication with a content distribution network, the Internet Protocol address corresponding to a computing device;
extracting a user agent for the Internet Protocol address and a history of content requests by the Internet Protocol address from a content distribution log associated with the content distribution network;
correlating the network traffic patterns with the user agent and the history of content requests to obtain network security data for the Internet Protocol address; and
generating network threat intelligence based on the network security data.

14. The one or more non-transitory tangible computer-readable storage media of claim 13, wherein the network threat intelligence includes a reputation score for the Internet Protocol address.

15. The one or more non-transitory tangible computer-readable storage media of claim 14, wherein the reputation score is generated based on one or more weighted threat attributes identified from the network security data.

16. The one or more non-transitory tangible computer-readable storage media of claim 14, wherein the reputation score is normalized based on one or more neighborhood scores, each of corresponding to an internet neighborhood of the IP address.

17. The one or more non-transitory tangible computer-readable storage media of claim 13, further comprising:
responding to a threat by the Internet Protocol address based on the network threat intelligence.

18. A system for identifying network threats, the system comprising:
a primary network in communication with a content distribution network, the primary network having one or more router interfaces through which network traffic for an Internet Protocol address is transceived, the Internet Protocol address corresponding to a computing device; and
a processing cluster configured to generate network threat intelligence based on network security data obtained from an interaction of the Internet Protocol address with the primary network and the content distribution network, the network security data including a network traffic dataset corresponding to the network traffic transceived over the one or more router interfaces for the Internet Protocol address and a content distribution log including a history of content requests from the Internet Protocol address over the primary network.

19. The system of claim 18, wherein the network threat intelligence includes a reputation score for the Internet Protocol address.

20. The system of claim 18, wherein the network threat intelligence includes a proposed response to a threat by the Internet Protocol address.
